(19) United States
(12) Patent Application Publication
(10) Pub. No.: US 2008/0129497 A1
(43) Pub. Date: Jun. 5, 2008

(54) Reconfigurable alarm apparatus

(76) Inventors: Jon Woodard, Seward, AK (US); Noel Woodard, Seattle, WA (US)

Correspondence Address: Noel Woodard, P.O. Box 19646, Seattle, WA, 98109-6646, US

(21) Appl. No.: 11/980,890

(22) Filed: Oct. 31, 2007

Related U.S. Application Data
(63) Continuation-in-part of application No. 10/660,224, filed on Sep. 11, 2003, now Pat. No. 7,089,269.
(60) Provisional application No. 60/858,595, filed on Nov. 13, 2006.

(51) Int. Cl. G08B 21/02

(52) U.S. Cl. 340/540

(57) ABSTRACT

A reconfigurable alarm apparatus for sensing a hazardous condition, and automatically transmitting emergency information and alerting occupants. In one aspect, the alarm apparatus may comprise a sensor and alarm controller interfaced with a software-defined radio module that is programmable from a remote information server to operate over a plurality of radio communication networks.

### CROSS REFERENCE TO RELATED APPLICATIONS

This patent application is a continuation-in-part, and claims the benefit of U.S. Non-provisional patent application Ser. No. 10/660,224, “Combination Smoke Alarm and Wireless Location Device,” by Noel Woodard and Jon Woodard, filed Sep. 11, 2003, now U.S. Pat. No. 7,019,646; and U.S. Non-provisional patent application Ser. No. 11/071,636, “Combination Carbon Monoxide and Wireless E-911 Location Alarm,” by Noel Woodard and Jon Woodard, filed Mar. 2, 2005, the disclosures thereof incorporated by reference in their entireties.

This patent application claims the benefit of U.S. Provisional patent application Ser. No. 60/898,595, by Jon Woodard and Noel Woodard, Filed Nov. 13, 2006, the disclosure thereof incorporated by reference herein in its entirety.

### BACKGROUND

1. Field of Invention

This disclosure relates generally to alarm devices and systems. More specifically, this disclosure provides a reconfigurable wireless alarm apparatus, and systems and methods thereof.

2. Description of Related Art

Alarm devices and systems that protect residential and commercial building structures from fire and carbon monoxide are presently available. These alarm devices and systems comprise a number of interconnected individual alarm devices with integrated sensors disbursed throughout a building. The alarm devices typically communicate an alarm event via a wired or wireless connection. These alarm devices are configured to communicate an alarm event throughout the protected building premises and/or off premises to a remote station or supervisory monitoring station.

Alarm devices employing wireless radio communication circuitry typically comprise one or more integrated application specific radio communication components, often for short-range communication between alarm devices and/or to an on premises central control panel connected to a remote station. These alarm devices typically communicate utilizing a single radio frequency and radio communication standard.

Alarm devices employing an application-specific radio communication component operating on limited frequencies have limitations. First, when improved radio communication technology is introduced, the hardware components cannot be reconfigured, thus the entire alarm device must be discarded. Second, if a simple software upgrade is desired, a time-consuming process is required to reconfigure each alarm. Third, since some of these devices may operate on a radio communication network, network traffic over a particular operating frequency in heavily populated areas may overburden a single wireless carrier's network system, leaving application-specific wireless devices temporarily without service during an emergency, even though other unused or underutilized frequency spectrum may be available. Moreover, a wide array of different types of radio communications technologies are in active service, characterized by dissimilar modulation methods, operating frequencies, and coding formats used to carry information over the radio airwaves.

A recent advancement in radio communication technology called software-defined radio or cognitive radio enables devices to communicate in areas where multiple, divergent network technologies are deployed, such as in the United States, where mobile telephone standards may include GSM and CDMA standards in one geographic area. A software-defined radio enabled device may be reconfigured to communicate over a wide-variety of radio communications, including: FM, VHF, cellular networks, wireless packet-switched IP networks, and wireless positioning networks utilizing global positing satellites, and broadcast television systems.

Therefore, a need exists to integrate a reconfigurable radio communication component into alarm devices and alarm systems. Integrating a software-defined radio communication component into alarm devices and alarm systems can overcome many of the existing limitations. Software-defined radio is an emerging technology that spans all radio network topologies, allowing one multipurpose radio communication device to be remotely programmed to communicate over multiple radio frequencies. Reconfigurable alarm devices can be employed in a wide variety of systems and applications, solving many of the shortcomings of alarm devices with integrated application-specific radio communication components.

### SUMMARY

Therefore, an object of the invention is to provide a reconfigurable alarm apparatus preferably comprising interconnected components including power supply, sensor, alarm controller, and a reconfigurable communication and positioning module. The reconfigurable communication and positioning module preferably comprises hardware components including a memory, RF signal processor, and controller. The memory may comprise one or more non-volatile and/or volatile memory components for storing radio reception and/or transmission specification information and various types of radio configurations that allows the reconfigurable communication and positioning module to communicate and operate utilizing one or more radio communication standards without hardware modifications. The memory is preferably utilized to temporarily or permanently store other information (e.g. emergency identification and positioning information) or programming.

It is another object of the invention that the reconfigurable alarm apparatus be configured to operate in a wide array of radio communication and positioning systems, which may comprise, alone or in combination, a wireless E911 location system, a packet-switched wireless local or wide area network, a broadcast television positioning system, a GPS, or other licensed or unlicensed radio communication systems.

It is another object of the invention to provide a reconfigurable alarm apparatus with reconfigurable sensor components, high-decibel, multi-mode audio and visual alarm components, and alarm status/disable and time delay components.

It is still another object of the invention to provide a reconfigurable audio alarm component, including a sound generating means, memory, a controller/processor and other hardware component means that allows the reconfigurable alarm apparatus to store, select, and emit one or more programmable audio alarm tone patterns and/or voice alarms.

It is another object of the invention to provide methods and systems for reconfiguring a communication and/or positioning specification of a reconfigurable alarm apparatus, and reconfiguring an audio alarm tone and/or synthesized voice pattern of a reconfigurable alarm apparatus, and provide a system for remotely monitoring building structures for fire and life safety regulation compliance preferably utilizing a reconfigurable alarm apparatus.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram illustrating a software-defined radio alarm apparatus according to one embodiment.

FIG. 2 is a flow chart showing a method and system for SDR alarm apparatus 5 reconfiguring a communication and/or positioning specification according to one illustrated embodiment.

FIG. 3 is a flow chart showing a method and system for reconfiguring an audio alarm tone pattern according to one illustrated embodiment.

FIG. 4 is a schematic showing a system for remotely monitoring building structures for fire and life safety regulation compliance according to one illustrated embodiment.

### DETAILED DESCRIPTION

In the description that follows, certain specific details are set forth in order to provide a thorough understanding of various embodiments. However, one skilled in the art will understand that the embodiments may be practiced without these details. In other instances, well known structures associated with software-defined radio (“SDR”) systems, alarm systems, global positioning satellite navigation systems, broadcast television systems, wireless packet-switched communication systems, and all other types of radio communication systems may not be shown or described in technical detail to avoid unnecessary obscuring descriptions of the embodiments. Unless the context requires otherwise, throughout the specification and claims which follow, the word “comprise” and variations thereof, such as, “comprises” and “comprising” are to be construed in an open, inclusive sense, that is as “including, but not limited to.”

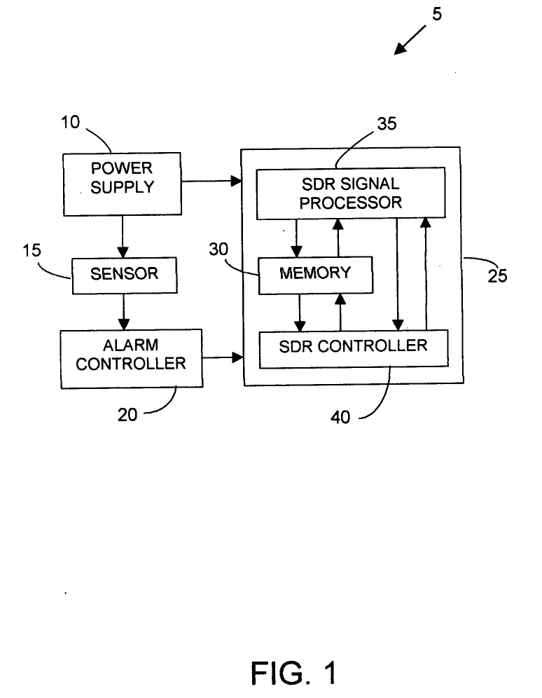

One embodiment and other variations of the software-defined radio multi-hazard alarm apparatus is shown as SDR alarm apparatus 5 in FIG. 1. SDR alarm apparatus 5 components are preferably confined in a housing (not shown), which can be fixed-mounted to a wall, ceiling, or other surface within a environment or building structure (not shown) configured to be occupied by at least one human being occupant. The environment or building structure may comprise a residential building including a number of living areas, and further comprise a means for generating smoke or carbon monoxide. Alternatively, the environment may be a mobile home, travel trailer, or recreational vehicle (not shown).

The human being occupant(s) may have physical or mental disabilities, or have limitations that hinder their ability to otherwise properly react to hazardous conditions (e.g. fire, carbon monoxide) and other emergency events.

The face or surfaces of the housing may comprise a plurality of slots or vents formed to allow the passage of air, smoke, or carbon monoxide into the interior region. The face of the housing can comprise a multitude of apertures or perforations for power status indicators, alarm status indicators and/or wireless radio frequency (“RF”) signal verification indicators. The housing can further comprise one or more buttons for a user to manually verify the operational status of power, sensor, and alarm circuitry of SDR alarm apparatus 5 during stand-by mode, or to execute a time delay function in alarm mode. The housing may further include one or more internal or external fixed-mounted antennas connected to SDR communication and positioning module 25, or be integrated into the housing composed of materials that serve as a means to transmit or receive radio frequency signals. Those skilled in the art will understand that many housing shapes or designs, and any configuration of apertures, indicators, displays, or buttons may be used to carry out the objectives of the embodiments herein described.

SDR alarm apparatus 5 may be configured to operate in a wide array of radio communication and positioning systems. Several embodiments of smoke and carbon monoxide alarm devices incorporating single and multiple mode cellular transceivers, global positioning satellite receivers, broadcast television receivers, and wireless local and wide area network transceivers are disclosed in U.S. Non-provisional patent application Ser. No. 10/660,224, “Combination Smoke Alarm and Wireless Location Device,” by Noel Woodard and Jon Woodard, filed Sep. 11, 2003, now U.S. Pat. No. 7,019,646; U.S. Non-provisional patent application Ser. No. 11/071,636, “Combination Carbon Monoxide and Wireless E-911 Location Alarm,” filed Mar. 2, 2005, by Noel Woodard and Jon Woodard; U.S. Non-provisional patent application Ser. No. 11/320,011, “Combination Alarm Device with Enhanced Wireless Notification and Position Location Features,” by Jon A. Woodard and Noel U. Woodard, filed Dec. 27, 2005, the disclosures thereof incorporated by reference herein in their entireties.

As illustrated in FIG. 1, SDR alarm apparatus 5 is a self-contained unit preferably comprising interconnected components including power supply 10, sensor 15, alarm controller 20, and SDR communication and positioning module 25. SDR alarm apparatus 5 preferably comprises components with low power consumption. In another embodiment (not shown) SDR alarm apparatus 5 may comprise a distributed system, with a centrally located control panel comprising communication components, and sensor and other alarm components disbursed throughout a building structure in communication with the central control panel.

In one example, SDR alarm apparatus 5 can detect a hazard in the environment that is dangerous to human being occupants (e.g. smoke, heat, carbon monoxide), alerting said occupants by audible or visual alarm signals (not shown), and activate SDR communication and positioning module 25 to initiate a wireless 911 emergency call or other emergency notification, and subsequently transmit signals comprising emergency identification and positioning information to a dispatch center, (e.g. a public safety answering point (“PSAP”)), or other emergency call recipients. A wireless communication and position location system, comprising at least a cellular or PCS system that is compliant with FCC wireless E911 regulations (“wireless E911 location system”), can also perform a position location sequence to measure the signals transmitted from SDR alarm apparatus 5 to determine the geographic location of SDR alarm apparatus 5. The PSAP subsequently dispatches public safety personnel to the location of SDR alarm apparatus 5.

As shown in FIG. 1, power supply 10 comprises AC and/or DC power sources to supply power to SDR alarm apparatus 5. A DC power source is preferably configured for providing power for a long duration (e.g. 10 years). Next shown in FIG. 1 is sensor 15, which comprises one or more reconfigurable sensors for detecting a hazardous condition in an environment. In another example, sensor 15 may comprise sensors employed in fire protection and suppression systems (e.g. flow sensors, pressure sensors, tamper sensors) that interconnect to alarm notification hardware components. Sensor 15 may comprise any combination of smoke, carbon monoxide, heat, or fire protection/suppression system sensors. Techniques for employing power sources and sensors in SDR alarm apparatus 5 are described in other patents, non-provisional patent applications, and provisional patent applications identified above and incorporated herein by reference in their entireties.

Also illustrated in FIG. 1 is alarm controller 20, which can comprise one or more programmed processing units, logic circuits, microprocessors, and memory components to carry out the detection and alarm functions of SDR alarm apparatus 5. Programming embedded in alarm controller 20 controls the overall operation of SDR alarm apparatus 5, by processing input signals from sensor 15 to determine hazardous conditions in the environment, and subsequently outputs alarm signals to other SDR alarm apparatus 5 alarm components. In a multiple sensor configuration (e.g. any combination of smoke, carbon monoxide, or heat sensors), alarm controller 20 can be configured to output a first unique alarm signal indicating a first type of hazard, a second unique alarm signal indicating a second type of hazard, and so on. Alarm controller 20 may include programming to automatically or manually execute a self-diagnostic routine that verifies the operational status of power, sensor, and alarm circuitry elements of SDR alarm apparatus 5.

Further illustrated in FIG. 1 and coupled to alarm controller 20 is SDR communication and positioning module 25, preferably comprising hardware components including a memory 30, RF signal processor 35, and SDR controller 40. SDR communication and positioning module 25 preferably comprises hardware component means that allow reconfiguration of its general RF signal properties, radio frequency, power, modulation, base band, and other operating parameters to utilize available radio spectrum that is available to SDR alarm apparatus 5 by radio communication and positioning systems in a given geographic area. The RF signals may be converted from analog to digital directly or through a intermediate hardware component.

Memory 30 may comprise one or more non-volatile and/or volatile memory components for storing radio reception and/or transmission specification information and various types of radio configurations (“communication specifications” or “positioning specifications”) that allows SDR communication and positioning module 25 to communicate and operate utilizing one or more radio communication standards without hardware modifications. Memory 30 is preferably utilized to temporarily or permanently store other information (e.g. emergency identification and positioning information) or programming further described below. Memory 30 preferably comprises a password protection feature to limit access to memory 30 and to prevent unauthorized reconfiguration or deletion of the communication and/or positioning specifications or other information stored in memory 30.

The communication and/or positioning specifications (e.g. stored in memory 30) preferably comprise radio communication technical standards (e.g. programming, machine readable instructions, algorithms, radio communication processes), or other radio communication instructions or information permanently or temporarily stored in memory 30 to allow reconfiguration of programmable circuitry components. Memory 30 may store one or more radio reception and/or transmission standards, with one or more default communication and/or positioning specifications.

The communication and positioning specifications (e.g. stored in memory 30) are configured to operate over a radio communication and positioning network systems serving a given geographic area, that are typically comprised of a plurality of radio communication standards, including but not limited to: analog or digital cellular communication standards (e.g. CDMA, GSM), short and long range wireless packet-switched network standards (e.g. IEEE 802.11a/b/g/n, 802.16 also known as Wi-Fi and Wi-Max respectively), global positioning satellite navigation system (“GPS”) standards (e.g. United States GPS, European Space Agency Galileo system), analog or digital broadcast television system standards (e.g. DTV, NTSC), aircraft or airship based radio communication systems, two-way radio standards, or other short or long range radio communication standards or methods (e.g. FM, VHF, UHF, passive or active RFID, Bluetooth). The radio communication systems may comprise one or more units, fixed and/or mobile, land-based, ocean-based, watercraft-based, orbital satellite based, or aircraft and/or airship based.

Memory 30 preferably stores communication and/or positioning specifications in a organized, tabulated format with associated encoding (e.g. alphanumeric electronic identity numbers associated to a frequency or channel) to identify such specifications to be accessed and managed by SDR controller 40 or other control means. The communication and/or positioning specifications are preferably approved by the FCC, or other entity that establishes or regulates radio communication and/or positioning standards.

RF signal processor 35 can comprise one or more programmable signal processing components including field programmable gate array devices, and/or programmable logic devices capable of reconfiguring a circuit arrangement in accordance with a communication and/or positioning specification, and processing of RF reception and/or transmission signals.

The SDR controller 40 preferably comprises one or more control circuitry elements, including microprocessors, logic circuits, memory, and programming or executable instructions to carry out the SDR communication and positioning module 25 functions in accordance with the communication and/or positioning specifications. SDR controller 40 programming or executable instructions allow reconfiguration of the communication and/or positioning specifications.

SDR controller 40 preferably comprises programming to search, compare, and select a communication and/or positioning specification based on the tabulated list of communication and/or positioning specifications with associated identity numbers stored in memory 30. SDR communication and positioning module 25 may comprise an integrated signal monitoring component and programming (not shown) to scan for external radio signals, to verify the reception and operational status (e.g. signal, power) of radio communication and positioning systems in a given geographic area, and to reconfigure, and, if necessary, automatically download, a communication and/or positioning specification based on the operational status of external radio signals.

The communication and/or positioning specifications are downloaded to SDR communication and positioning module 25, preferably via a communication network comprising a wired connection (e.g. internet, LAN), and/or radio connection (e.g. radio communication network, or wireless IP-based packet-switched local or wide area network) from a remote information server component (not shown). A remote information server component preferably comprises hardware means, including a user interface means, information processing means, storage means, a modem means (e.g. a wired or radio communication means in communication with SDR alarm apparatus 5). The server storage means is preferably configured to store, access, reconfigure, send, receive or otherwise manage one or more communication and/or positioning specifications and other information. The communication and/or positioning information is preferably stored in a tabulated format with associated identity number.

The information server preferably comprises a password protection feature to limit access and to prevent unauthorized reconfiguration or deletion of the stored communication and/or positioning specifications. The communication and/or positioning specifications contained in the storage means are preferably encrypted to prevent reconfiguration of the communication and/or positioning specification standard.

The server may be accessible by a user or other entity that is permitted to reconfigure SDR alarm apparatus 5 by causing to be downloaded one or more communication and/or positioning specifications. An entity may comprise a commercial or governmental unit that either manages, monitors, controls, or regulates one or more SDR alarm apparatus 5 or SDR-enabled alarm system.

SDR communication and positioning module 25 is preferably configured to allow a user to visually verify that SDR alarm apparatus 5 has sufficient wireless service signals in order to transmit and/or receive signals or otherwise communicate with radio communication and/or positioning systems. SDR alarm apparatus 5 may comprise hardware components (not shown), including one or more LED's or other visual indicator means (e.g. liquid crystal display), preferably configured to display alphanumeric characters or a graphical means to allow a user to visually verify the operational status of SDR communication and positioning module 25. In addition, SDR communication and positioning module 25 may comprise a audio hardware component to alert a user of the sufficiency of a wireless service signal to SDR alarm apparatus 5.

SDR communication and positioning module 25 further comprises programmed instructions to automatically initiate an emergency call sequence, which involves transmitting emergency identification and positioning information stored in memory 30 to a dispatch center or other emergency call recipients. The emergency identification and positioning information that is stored in memory 30 comprises a transmitter, receiver, and/or transceiver's device identification number, including but not limited to a Mobile Identity Number, Electronic Serial Number, International Mobile Equipment Identity, Mobile Station Identifier, or other identity numbers consisting of sequences of characters and/or digits, which are typically used to identify a radio communication device in a radio communication system. The emergency identification information preferably comprises additional encoding that identifies the type of emergency (e.g. fire, CO), personal data (e.g. age, disability), building data (e.g. schematics), or other information which is embedded in the wireless emergency call and routed to a dispatch center, mobile station, or other call recipient. The types or information stored in memory 30 are not limited in scope to this description, and can comprise other information and techniques described in other patents, non-provisional patent applications, and provisional patent applications identified above and incorporated herein by reference in their entireties.

In this embodiment and other examples, SDR alarm apparatus 5 may be configured to operate in wireless communication and positioning network infrastructures which may comprise, alone or in combination, a wireless E911 location system, a packet-switched wireless local or wide area network, a broadcast television positioning system, and a GPS, further described below. Although SDR alarm apparatus 5 may utilize these infrastructures alone or in combination depending on the availability of the infrastructures in a given geographic area, SDR alarm apparatus 5 is preferably configured to utilize wireless communication and position location infrastructures that provide enhanced or increased wireless positioning accuracy. SDR alarm apparatus 5 can be configured to operate in wireless E911 location systems that are upgraded and configured to comply with the mandated FCC Phase I and/or Phase II standards governing wireless locations systems being deployed in any given area or region. Employing alarm devices in wireless communication and positioning systems are described in other patents, non-provisional patent applications, and provisional patent applications identified above and incorporated herein by reference in their entireties.

In one example, SDR communication and positioning module 25's communication and/or positioning specifications may be configured to operate and communicate in analog or digital cellular/PCS networks, utilizing one or more mobile telephone RF bands, one or more mobile telephone air interface standards (e.g. CDMA, GSM, AMPS, TDMA), and/or utilize wireless data transfer protocols (e.g. SMS, CDPD, GPRS) configured to operate in cellular or PCS networks and wireless E911 location systems. In this example, SDR alarm apparatus 5 may be non-service initialized, allowing the user to forego obtaining a mobile telephone carrier subscriber/service contract to operate SDR alarm apparatus 5. Techniques for operating and communicating in various radio communications and positioning systems are described in other patents, non-provisional patent applications, and provisional patent applications identified above and incorporated herein by reference in their entireties.

In another example, SDR communication and positioning module 25 communication and/or positioning specification is reconfigured to operate and communicate utilizing a wireless packet-switched local area network (“WLAN”) specification (e.g. IEEE 802.11 a/b/g, known as Wi-Fi), and a data source of known WLAN radio communication transmission and/or reception stations (“access points”). In a variation of this example, the communication and/or positioning specification can be reconfigured to operate and communicate utilizing a packet-switched wide area network specification (e.g. IEEE 802.16, known as Wi-Max). In these examples, the packet-switched local or wide area networks preferably comprise an internet communication protocol (“IP”).

In this example, the positioning specification is preferably configured for positioning utilizing WLAN access points, a data source of known WLAN access points, and application software and other means for WLAN positioning. Upon receiving a activation signal, SDR communication and positioning module 25 is enabled to scan available WLAN access points, collecting identification information, and comparing this to a data source or lookup-table containing WLAN access point information. SDR communication and positioning module 25 utilizes the access point and data source information to determine a geographic location of SDR alarm apparatus 5. In this example, SDR communication and positioning module 25 comprises programmed instructions to automatically initiate an emergency call sequence, which involves transmitting emergency identification and WLAN positioning information to a dispatch center or other designated recipients.

In another example, SDR communication and positioning module 25 is reconfigured to operate and communicate utilizing a combination of radio communication systems including analog or digital cellular/PCS networks and packet-switched local or wide area networks or other unlicensed radio communication technologies. In this example, SDR communication and positioning module 25 hardware components and programming are preferably reconfigured with one or more communication and/or positioning specifications to allow a signal transition as a mobile SDR alarm apparatus 5 travels between the aforementioned radio communication systems. In this example, a mobile variation of SDR alarm apparatus 5 (e.g. installed in a recreational vehicle, travel trailer, or other motor vehicle) is allowed to transition or roam between one or more radio communication and positioning systems without losing a RF communication signal.

In another example, SDR communication and positioning module 25 positioning specification is reconfigured to operate and communicate utilizing a GPS receiver specification in GPS system operated by the United States (“U.S. GPS”), including Assisted GPS (“A-GPS”), Differential GPS, and Wide Area Augmentation System. SDR communication and positioning module 25 can be reconfigured to communicate and operate in other positioning systems deployed by other countries that utilize other means to augment a U.S. GPS signal. For example, the European Space Agency (“ESA”) is currently employing and developing a system called European Geostationary Navigation Overlay Service (“EGNOS”) Terrestrial Regional Augmentation Network (“TRAN”). EGNOS-TRAN is a network of about forty ground stations dispersed throughout Europe to optimize data signals from the U.S. GPS system. The optimized signals are relayed through the EGNOS-TRAN network to EGNOS enabled receiver devices. The EGNOS-TRAN optimized signals have increased positioning accuracy over the raw signals received directly from the U.S. GPS system. Still another satellite positioning system under development is the ESA Galileo satellite navigation system. Galileo is planned to comprise about thirty satellites, and is projected to provide increased positioning accuracy to non-military users than the U.S. GPS system. Thus, SDR communication and positioning module 25 may comprise any type of GPS receivers, GPS positioning specifications, or other hardware components or specifications for augmented positioning. Techniques for incorporating a GPS receiver specification in alarm devices are described in other patents, non-provisional patent applications, and provisional patent applications identified above and incorporated herein by reference in their entireties.

In another example, SDR communication and positioning module 25 communication and positioning specification is reconfigured to operate and communicate utilizing a broadcast television receiver specification that operates in a broadcast television position location system, and configured to receive digital and/or analog television signals from one or more television transmitters. The communication and/or positioning specification can comprise broadcast television standards including: American Television Standards Committee (“ATSC”) Digital Television (“DTV”) signals, and/or National Television System Committee (“NTSC”) Analog Television. (“TV”#) signals. Other examples may comprise receiving European Telecommunications Standards Institute (“ETSI”) Digital Video Broadcasting Television (“DVB-T”) signals, or Japanese Integrated Services Digital Broadcasting Terrestrial (“ISDB-T”) signals. Techniques for incorporating broadcast television receiver hardware components in alarm devices that operate in a broadcast television position location system are described in other patents, non-provisional patent applications, and provisional patent applications identified above and incorporated herein by reference in their entireties.

Those skilled in the art will understand that SDR communication and positioning module 25 can be reconfigured with a wide array of communication and/or positioning specifications. Additionally, those skilled in the art will understand that SDR alarm apparatus 5 can combine with SDR communication and positioning module 25 any other application-specific radio communication and positioning hardware components, including radio transceivers, transmitters, and/or receivers (e.g. cellular, WLAN, GPS, FM), or other radio communication and wireless positioning standards or protocols, including those described in other patents, non-provisional patent applications, and provisional patent applications identified above and incorporated herein by reference in their entireties.

In another example, SDR communication and positioning module 25 positioning specification is reconfigured to operate and communicate utilizing other radio communication specifications (e.g. WLAN, Bluetooth, ultra-wideband, FM, passive or active RFID) for wireless interconnection and communication of a plurality of remotely located SDR-enabled alarms. Wireless interconnection and communication allows a plurality of SDR-enabled alarms to transmit and/or receive a variety of information, including alarm activation signals, RF signal verification, alarm positioning, and other communication signals. This example may also comprise additional SDR communication hardware components or additional application-specific radio communication hardware components to carry out the interconnection functions between a plurality of SDR alarms. Other examples of alarm interconnection circuitry including but not limited to audio alarm interconnections, AC power line carrier alarm interconnections that may be employed in SDR alarm apparatus 5 are described in other patents, non-provisional patent applications, and provisional patent applications identified above and incorporated herein by reference in their entireties.

In other examples, SDR alarm apparatus 5 comprises a high-decibel, multi-mode audio alarm components and high-candela visual alarm components (not shown) to alert human occupants to a hazardous condition. Audio alarm and/or visual alarm components are connected to alarm controller 20. Techniques for employing audio and visual alarm components are described in other patents, non-provisional patent applications, and provisional patent applications identified above and incorporated herein by reference in their entireties.

In another example, SDR alarm apparatus 5 preferably comprises a reconfigurable audio alarm component means (not shown), including a sound generating means, memory, a controller/processor and other hardware component means that allows SDR alarm apparatus 5 to store, convert, select, and emit one or more high-decibel programmable audio alarm tone and/or synthesized voice patterns. The reconfigurable audio alarm tone and/or synthesized voice patterns are preferably uniquely configured to alert at-risk human occupants (e.g. children, elderly, incapacitated) of hazards in the environment. The synthesized voice pattern may comprise a plurality of voice commands in a plurality of human languages. The reconfigurable audio alarm component is connected to alarm controller 20, and configured to receive an alarm activation signal.

The reconfigurable audio alarm tone and/or synthesized voice patterns may be downloaded to a memory from via a wired connection (e.g. internet), or radio channel (e.g. radio communication network) from a remote information server component (not shown). A remote information server component preferably comprises hardware means, including a user interface means, storage means, and a modem means (e.g. a wired or radio communication means in communication with SDR alarm apparatus 5). The server storage means is preferably configured to store, access, reconfigure, send, receive or otherwise manage one or more reconfigurable audio alarm tone and/or synthesized voice patterns and other information. The server may be accessible by a user or other entity that is permitted to reconfigure SDR alarm apparatus 5 by causing to be downloaded one or more reconfigurable audio alarm tone and/or synthesized voice patterns. An entity may comprise a commercial or governmental unit that either manages, monitors, controls, or regulates one or more SDR alarm apparatus or system.

Other examples of SDR alarm apparatus 5 comprise multipurpose alarm status/disable and time delay circuitry (not shown), provided to automatically or manually execute a diagnostic routine that verifies the operational status of power, sensor, and alarm circuitry elements of SDR alarm apparatus 5, to suppress nuisance alarm events or inadvertent “non-emergency” calls, and execute a time delay to temporarily delay the output of alarm signals from alarm controller 20 to SDR communication and positioning module 25 (or components thereof) for predetermined time periods. Techniques for employing multipurpose alarm status/disable and time delay circuitry in alarm devices are described in other patents, non-provisional patent applications, and provisional patent applications identified above and incorporated herein by reference in their entireties.

Those skilled in the art will understand that SDR alarm apparatus 5 can be configured in a variety of SDR enabled alarm system embodiments integrating SDR or cognitive radio components in a variety of radio communication and information network systems. For example, alarm system configurations may comprise a distributed alarm system equipped with hardware components including but not limited to sensors and SDR communication modules in communication with a centralized monitoring component (e.g. a on-site control panel, remote supervisory monitoring station). A centralized monitoring component may comprise a public safety or governmental entity that supervises such alarm systems via a communications network connection specialized for governmental entity services (e.g. municipal, county, state).

In this alarm system example, the centralized monitoring component may be configured to submit a request to an information server component to reconfigure alarm communication and/or positioning specifications in said distributed alarm system. In another example, a centralized monitoring component may be configured to submit a request to an information server component to reconfigure one or more alarm tone patterns in said distributed alarm system.

Those skilled in the art will understand that many configurations of systems and methods exist for utilizing SDR alarm apparatus 5 and other SDR-enabled alarm systems. Methods for automatically determining the geographic location of SDR alarm apparatus 5, and automatically notifying a dispatch center or other call recipient of the location of an emergency are described in other patents, non-provisional patent applications, and provisional patent applications identified above and incorporated herein by reference in their entireties.

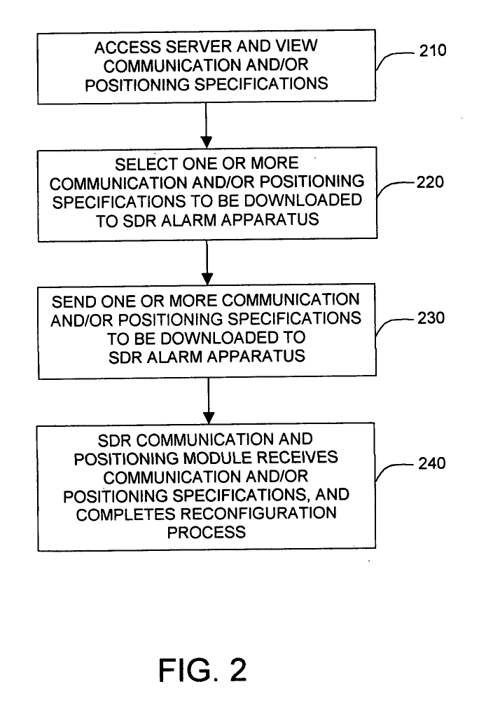

A method and system for reconfiguring a communication and/or positioning specification in SDR alarm apparatus 5 is shown in FIG. 2. A reconfiguration of communication and/or positioning specification may be performed for several reasons, including: 1) the availability of operational radio communication services in a given geographic area, where a type of service is unavailable, or new types of services are now available, 2) a change in radio communication technology, where a new communication and/or positioning specification standard, or merely a change in the type of communication and/or positioning specification is desired by a user or entity; 3) a change in the communication and/or positioning specification is mandated by a governmental entity or other standard-making entity. Those skilled in the art will understand that other reasons may require a reconfiguration of the communication and/or positioning specifications in SDR alarm apparatus 5 or other SDR-enabled alarm systems.

The steps depicted in FIG. 2 should not be limited in scope to the specifics of SDR alarm apparatus 5, and may incorporate other embodiments or features. Additionally, the steps described below in FIG. 2 may reference additional or alternate steps comprising further embodiments.

In the first step 210, a user or entity accesses the remote information server component with stored communication and/or positioning specifications. A user or entity accessing the server may utilize a user interface means to view a list of one or more communication and/or positioning specifications that are available in the server storage means.

In step 220, a user or entity may then select one or more communication and/or positioning specifications to be downloaded to SDR alarm apparatus 5 or other SDR-enabled alarms. The information server preferably confirms the selection with the user or entity.

In step 230, one or more communication and/or positioning specification is sent or transmitted from the server to SDR alarm apparatus 5 or other SDR-enabled alarms over a communication network in communication with SDR alarm apparatus 5.

In step 240, SDR communication and positioning module 25 receives and downloads one or more communication and/or positioning specifications to memory 30 utilizing appropriate hardware and software means. SDR controller 40 then reconfigures SDR communication and positioning module 25 to the communication and/or positioning specification. SDR communication and positioning module 25 preferably outputs a signal to the user or entity verifying that the communication and/or positioning specification was downloaded and is operational. SDR alarm apparatus 5 is now enabled to communicate with the desired radio communication and positioning network in accordance with the downloaded communication and/or positioning specification.

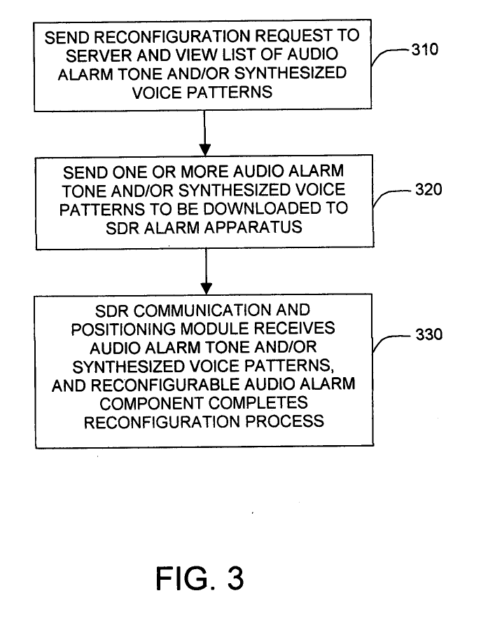

In FIG. 3, a method and system for reconfiguring an audio alarm tone and/or synthesized voice pattern is shown. A reconfiguration of audio alarm tone and/or synthesized voice patterns may be performed for several reasons. A primary reason is to provide a specially configured audio alarm tone pattern is to accommodate a person with special needs (e.g. children, elderly, incapacitated) of hazards in the environment. For example, hearing impaired persons, the elderly, or children may not react to a conventional audio alarm tone pattern. Scientific studies indicate that these persons react to specialized audio alarm tone patterns. In other cases, a reconfiguration of an audio alarm tone and/or synthesized voice pattern is mandated by a governmental entity or other standard-making entity. Those skilled in the art will understand that other reasons may require a reconfiguration of audio alarm tone and/or synthesized voice patterns in SDR alarm apparatus 5, other SDR-enabled alarm systems, or even conventional alarms

The steps depicted in FIG. 3 should not be limited in scope to the specifics of SDR alarm apparatus 5, and may incorporate other embodiments or features. Additionally, the steps described below in FIG. 3 may reference additional or alternate steps comprising further embodiments.

In the first step 310, a user or entity sends or a reconfiguration request to a remote information server component with stored audio alarm tone and/or synthesized voice patterns. A user or entity accessing the server may utilize a user interface means to view a list of one or more audio alarm tone and/or synthesized voice patterns that are available in the server storage means. A user or entity may then select a audio alarm tone and/or synthesized voice patterns to be downloaded. The information server preferably confirms the selection with the user or entity.

In step 320, one or more audio alarm tone and/or synthesized voice patterns are sent or transmitted from the server to SDR alarm apparatus 5 other SDR-enabled alarms over a communication network in communication with SDR alarm apparatus 5.

In step 330, SDR communication and positioning module 25 receives and downloads one or more audio alarm and/or synthesized voice tone patterns to reconfigurable audio alarm component means (not shown), to be stored in memory means utilizing appropriate hardware and software means. SDR alarm apparatus 5 is now enabled to emit a specialized audio alarm tone and/or synthesized voice pattern upon activation.

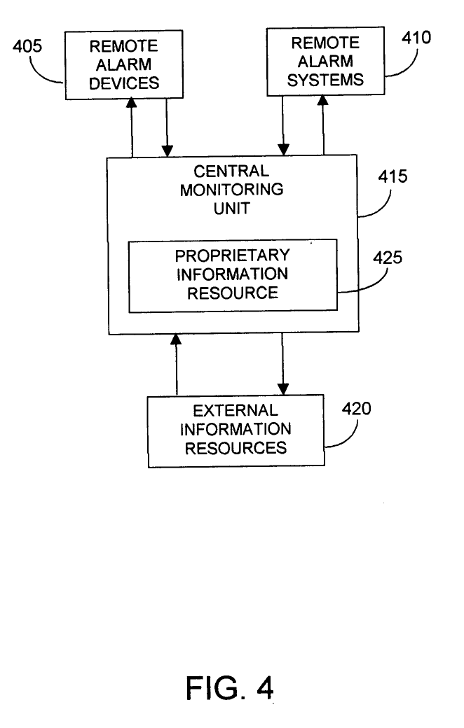

In FIG. 4, a system for remotely monitoring building structures for fire and life safety regulation compliance is shown. The system depicted in FIG. 4 should not be limited in scope to the specifics of SDR alarm apparatus 5 or SDR-enabled alarm systems, and may incorporate other alarm systems, embodiments, and features. Additionally, FIG. 4 is not limited in scope to monitoring building structures, and may comprise monitoring other assets (e.g. equipment, furniture).

A system for remotely monitoring fire and life safety regulation compliance in building structures may comprise remote alarm devices 405 or remote alarm systems 410 in communication with a central monitoring unit 415, supervised by a user, or a commercial or governmental entity. The system may comprise one or more connected external information resources 420 (e.g. servers, databases, data warehouses) configured to store and process information. Central monitoring unit 415 may comprise a proprietary information resource 425 (e.g. servers, databases, data warehouses) connected and in communication with to external information resources 420. External information resources 420 and proprietary information resource 425 are preferably configured to store information in a structured data format.

Remote alarm devices 405 and remote alarm systems 410 are configured to monitor for hazardous conditions in building environments (e.g. residential, or other buildings) or other assets (not shown), and communicate a hazardous condition to an external monitoring unit (e.g. dispatch center or other designated recipient) (not shown). Remote alarm devices 405 and remote alarm systems 410 may comprise active or passive hardware components, including but not limited to power sources, sensors, controllers, and audio, visual, and communication and/or notification components. Remote alarm devices 405 and remote alarm systems 410 have various characteristics, features, and/or specifications preferably governed by municipal, county, state, or federal fire or life safety regulations.

Central monitoring unit 415 is preferably configured to communicate with remote alarm devices 405 and remote alarm systems 410 via a communication networks comprising a wired connection (e.g. internet, LAN), or radio connection (e.g. radio communication network, or wireless TP-based packet-switched local or wide area network). Central monitoring unit 415 preferably comprises a user interface configured to monitor the remote alarm devices 405 and remote alarm systems 410 for compliance with municipal, county, state, or federal fire or life safety regulations.

The building structures (not shown) monitored by remote alarm devices 405 and/or remote alarm systems 410 comprises various characteristics, features, configurations, and/or specifications, which may be governed by municipal, county, state, or federal building regulations.

External information resources 420 may be configured to store, process, and update municipal, county, state, or federal fire, life safety, building, and/or persons with special needs regulations, accessible by the central monitoring unit 415 and proprietary information resource 425. Alternatively, proprietary information resource 425 may store, process, and update municipal, county, state, or federal fire, life safety, building, and/or persons with special needs regulations.

External information resources 420 may be configured to store, process, and update other information about the building structures in a certain geographic area or political subdivision, including: utility information (power sources, heat sources), building characteristics, features, configurations, and/or specification information (number of levels, rooms, sleeping areas, occupancy), building location (street address, longitude/latitude), current occupancy (occupied or vacant), and other requirements, such as accommodations for persons with special needs.

Central monitoring unit 415 personnel may access and query external information resources 420 and/or proprietary information resource 425 to determine if a specific building structure or asset and remote alarm devices 405 or remote alarm systems 410 are in compliance with municipal, county, state, or federal fire, life safety, building, and/or persons with special needs regulations.

We claim:

1. A reconfigurable alarm apparatus, comprising:
a sensor for detecting a hazardous condition;
a alarm controller, in communication with the sensor, the controller configured to generate a alarm signal in response to the sensor detecting the condition;
a software-defined radio communication and positioning module in communication with the controller, the module having one or more integrated memory, RF signal processor, and controller, wherein a first memory comprises at least one of a programmable communication and positioning specification, configured to communicate with at least one of a communication and positioning network;
wherein a second memory comprises a stored emergency identification information, comprising at least a geographic location of the reconfigurable alarm apparatus;
wherein the module is configured to automatically and contemporaneously transmit the emergency identification information upon receiving the alarm signal from the alarm controller.

2. The reconfigurable alarm apparatus of claim 1, wherein the communication and positioning network comprises at least one of a cellular radio communication network means, a wireless packet-switched communication network means, a global positioning satellite system means, and a broadcast television system means.

3. The reconfigurable alarm apparatus of claim 1, wherein the geographic location of the reconfigurable alarm apparatus is determined by at least one of a cellular radio communication network means, a wireless packet-switched communication network means, a global positioning satellite system means, and a broadcast television system means.

4. The reconfigurable alarm apparatus of claim 1, wherein the software-defined radio module is programmable from a remote information server over a communication network.

5. The reconfigurable alarm apparatus of claim 4, wherein the communication network comprises a radio communication network.

6. The reconfigurable alarm apparatus of claim 1, wherein the communication and positioning specification comprise one or more radio communication standards.

7. The reconfigurable alarm apparatus of claim 6, wherein the radio communication standards comprise at least one of a cellular radio communication network communication standard, a wireless packet-switched communication network communication standard, a global positioning satellite system communication standard, and a broadcast television system communication standard.

8. The reconfigurable alarm apparatus of claim 1, further comprising at least one of a global positioning satellite system receiver means, in communication with the software-defined radio module, a cellular transceiver means in communication with the software-defined radio module, a wireless packet switched network transceiver means in communication with the software-defined radio module, a broadcast television system receiver means in communication with the software-defined radio module.

9. The reconfigurable alarm apparatus of claim 1, wherein the software-defined radio module comprises a field programmable gate array means.

10. The reconfigurable alarm apparatus of claim 1, wherein the memory further comprises a wireless enhanced 911 feature.

11. The reconfigurable alarm apparatus of claim 1, further comprising: a visual radio frequency signal verification feature.

12. The reconfigurable alarm apparatus of claim 1, wherein the sensor comprises at least one of a smoke sensor, a carbon monoxide sensor, and a heat sensor.

13. The reconfigurable alarm apparatus of claim 1, wherein the sensor comprises at least one of a flow sensor, a pressure sensor, and a valve tamper sensor in a fire protection/suppression system.

14. The reconfigurable alarm apparatus of claim 1, wherein the alarm controller is coupled to a audible alarm means that activates when a signal is received from the sensor.

15. The reconfigurable alarm apparatus of claim 1, wherein the alarm controller is coupled to a visual alarm means that activates when a signal is received from the sensor.

16. The reconfigurable alarm apparatus of claim 1, wherein the alarm controller is coupled to a reconfigurable audio alarm component means for emitting at least a programmable audio alarm tone.

17. The reconfigurable alarm apparatus of claim 16, wherein the programmable audio alarm tone is at least a synthesized human voice configured to communicate in a plurality of human languages.

18. The reconfigurable alarm apparatus of claim 16, wherein the reconfigurable alarm component is programmable from a remote location.

19. A method and system for reconfiguring a radio communication specification is a software-defined radio alarm apparatus, comprising the steps of:
accessing a remote information server component with stored radio communication specifications, wherein the user or entity accessing the server may utilize a user interface means to view a list of one or more radio communication specifications that are stored in a server storage means;
sending a radio communications specification, wherein the server sends one or more radio communication specifications over a communication network in communication with the software-defined radio alarm apparatus;
receiving one or more radio communication specifications, wherein the software-defined radio alarm apparatus receives one or more radio communication specifications and is reconfigured to communicate over a radio communication system.

20. A system for remotely monitoring fire and life safety regulation compliance in building structures, comprising:
at least one of a remote alarm device means, confined within a building structure;
at least one of a remote alarm system means, confined within a building structure;
a supervised central monitoring unit means in communication with the alarm devices and alarm systems;
a external information resource means, in communication with the central monitoring unit, configured to store, process, and update at least one of a fire regulation, a life safety regulation, a building regulation, and a person with special needs regulation;
a proprietary information resource means, in communication with the central monitoring unit and external information resource;
wherein the central monitoring unit monitors if the building structures are in compliance with the fire, life safety, building, and persons with special needs regulations.
